(19) United States
(12) Patent Application Publication
(10) Pub. No.: US 2023/0252150 A1
(43) Pub. Date: Aug. 10, 2023

(54) SOFTWARE CORRECTING APPARATUS, SOFTWARE CORRECTING METHOD, AND NON-TRANSITORY COMPUTER READABLE MEDIUM

(71) Applicant: NEC Corporation, Minato-ku, Tokyo (JP)

(72) Inventors: Yusuke SHIMADA, Tokyo (JP); Takayuki SASAKI, Tokyo (JP)

(73) Assignee: NEC Corporation, Minato-ku, Tokyo (JP)

(21) Appl. No.: 18/008,770

(22) PCT Filed: Jun. 9, 2020
(86) PCT No.: PCT/JP2020/022747

§ 371 Date: Dec. 7, 2022

(51) Int. Cl. G06F 21/56; G06F 21/55

(52) U.S. Cl. CPC G06F 21/566; G06F 21/552; G06F 2221/033

(57) ABSTRACT

In a software correcting apparatus, a specification unit specifies a plurality of code blocks contained in a target software. A checking unit determines, for each of the specified code blocks, whether or not the specified code block is a code block that is possibly a backdoor, and specifies a code block that is determined to be possibly a backdoor as a backdoor block. A correction processing unit performs an execution-disabling process or a putting-under-surveillance process on the backdoor block contained in the target software. The execution-disabling process is a process for changing the state of the backdoor block into a state in which it cannot be executed. The putting-under-surveillance process is a process for handling the backdoor block as a subject that should be monitored when it is executed.

### TECHNICAL FIELD

The present disclosure relates to a software correcting apparatus, a software correcting method, and a non-transitory computer readable media.

### BACKGROUND ART

Patent Literature 1 proposes a technology for removing software from a management system when it is suspected that the software is infected with a virus.

It should be noted that infrastructures and corporate systems are becoming more and more complicated. Therefore, infrastructures and corporate systems are not constructed solely from devices manufactured by the same company. Instead, they are constructed by acquiring devices from various outside companies and combining them.

Further, in recent years, there have been a number of reports of incidents in which, in such devices, hidden functions that are not known (e.g., not disclosed) to users or functions that are not expected by users are found to have been incorporated as a part of software (firmware) or hardware. That is, a number of incidents involving “backdoors” have been reported. A “backdoor” can be defined as, for example, a function that is not disclosed to and not desired by users, and is incorporated as a part of software including a plurality of functions.

### CITATION LIST

### Patent Literature

Patent Literature 1: Published Japanese Translation of PCT International Publication for Patent Application, No. 2015-531508

### SUMMARY OF INVENTION

### Technical Problem

The inventors of the present application have found the following problem. That is, even in a case where a code block that could be a backdoor (i.e., a backdoor block) is found in software, if the software is entirely deleted as in the case of the technology disclosed in Patent Literature 1, the software in which most of the code blocks are normal blocks rather than backdoor blocks cannot be used. In other words, the inventors of the present application have found that there is a need for effectively using software including a backdoor block.

An object of the present disclosure is to provide a software correcting apparatus, a software correcting method, and a non-transitory computer readable medium capable of enabling software containing a backdoor block to be used.

### Solution to Problem

A software correcting apparatus according to a first aspect includes:
specification means for specifying a plurality of code blocks contained in software to be checked;
checking means for determining, for each of the specified code blocks, whether or not the specified code block is a code block that is possibly a backdoor, and specifying a code block that is determined to be possibly a backdoor as a backdoor block; and
correction processing means for performing an execution-disabling process or a putting-under-surveillance process on the backdoor block contained in the software, the execution-disabling process being a process for changing the state of the specified backdoor block into a state in which it cannot be executed, and the putting-under-surveillance process being a process for handling the specified backdoor block as a subject that should be monitored when the specified backdoor block is executed.

A software correcting method according to a second aspect includes:
specifying a plurality of code blocks contained in software to be checked;
determining, for each of the specified code blocks, whether or not the specified code block is a code block that is possibly a backdoor, and specifying a code block that is determined to be possibly a backdoor as a backdoor block; and
performing an execution-disabling process or a putting-under-surveillance process on the backdoor block contained in the software, the execution-disabling process being a process for changing the state of the specified backdoor block into a state in which it cannot be executed, and the putting-under-surveillance process being a process for handling the specified backdoor block as a subject that should be monitored when the specified backdoor block is executed.

A non-transitory computer readable medium according to a third aspect stores a program for causing a software correcting apparatus to:
specify a plurality of code blocks contained in software to be checked;
determine, for each of the specified code blocks, whether or not the specified code block is a code block that is possibly a backdoor, and specify a code block that is determined to be possibly a backdoor as a backdoor block; and
perform an execution-disabling process or a putting-under-surveillance process on the backdoor block contained in the software, the execution-disabling process being a process for changing the state of the specified backdoor block into a state in which it cannot be executed, and the putting-under-surveillance process being a process for handling the specified backdoor block as a subject that should be monitored when the specified backdoor block is executed.

### Advantageous Effects of Invention

According to the present disclosure it is possible to provide a software correcting apparatus, a software correcting method, and a non-transitory computer readable medium capable of enabling software containing a backdoor block to be used.

### BRIEF DESCRIPTION OF DRAWINGS

FIG. 1 is a block diagram showing an example of a software correcting apparatus according to a first example embodiment;

FIG. 2 is a block diagram showing an example of a software correcting apparatus according to a second example embodiment;

FIG. 3 is diagram for explaining a control flow graph;

FIG. 4 is diagram for explaining a dead code;

FIG. 5 is a flowchart showing an example of processing operations performed by the software correcting apparatus according to the second example embodiment; and

FIG. 6 shows an example of a hardware configuration of a software correcting apparatus.

### EXAMPLE EMBODIMENT

An example embodiment will be described hereinafter with reference to the drawings. Note that, in the example embodiment, the same reference numerals (or symbols) are assigned to the same or equivalent components, and redundant descriptions thereof are omitted.

### First Example Embodiment

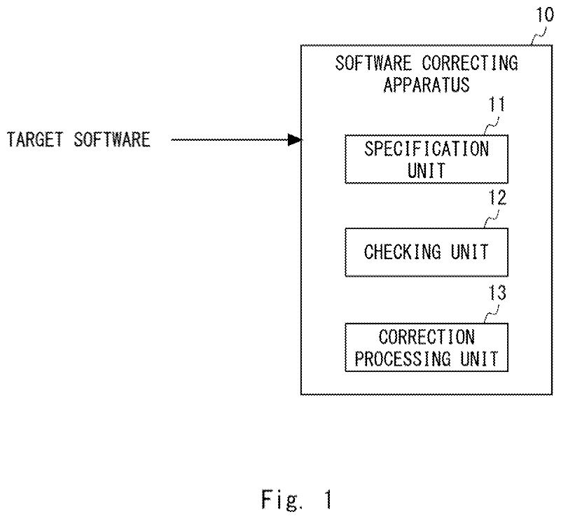

FIG. 1 is a block diagram showing an example of a software correcting apparatus according to a first example embodiment. As shown in FIG. 1, a software correcting apparatus 10 includes a specification unit 11, a checking unit 12, and a correction processing unit 13.

The software correcting apparatus 10 receives software to be checked (hereinafter also referred to as “target software”). The target software may be a source code before it is compiled or a binary code after it is compiled.

The specification unit 11 specifies a plurality of “code blocks” contained in the target software. The “code block” may be, for example, a function block corresponding to a function included in the target software, or a basic block that has a size smaller than that of the function block.

The checking unit 12 determines, for each of the specified code blocks, whether or not the specified code block is a code block that is possibly a backdoor, and specifies a code block(s) that is determined to be possibly a backdoor(s) as a “backdoor block(s) (backdoor block candidate(s))”.

The correction processing unit 13 performs an “execution-disabling process” or a “putting-under-surveillance process” on the backdoor block contained in the target software. The “execution-disabling process” is a process for changing the state of the backdoor block into a state in which it cannot be executed. The “execution-disabling process” may include a “removal process” for removing the backdoor block from the target software or an “invalidation process” for invalidating the backdoor block. Further, the “putting-under-surveillance process” is a process for handling the backdoor block as a subject that should be monitored when it is executed. The “putting-under-surveillance process” may include an “insertion process” for inserting a “monitoring code” for monitoring the backdoor block into the target software.

According to the above-described configuration of the software correcting apparatus 10, it is possible to change the state of the backdoor block(s) contained in the target software, rather than the whole target software including the backdoor block(s), into a state in which it cannot be executed, or handling the backdoor block(s) as a subject(s) to be monitored. In this way, it is possible to enable the software containing the backdoor block to be used, and thereby to effectively use the software containing the backdoor block.

Note that the software correcting apparatus 10 performs the following software correcting method. That is, the software correcting method includes: specifying a plurality of code blocks contained in software to be checked; determining, for each of the specified code blocks, whether or not the specified code block is a code block that is possibly a backdoor, and specifying a code block that is determined to be possibly a backdoor as a backdoor block; and performing an execution-disabling process or a putting-under-surveillance process on the backdoor block contained in the software, the execution-disabling process being a process for changing the state of the specified backdoor block into a state in which it cannot be executed, and the putting-under-surveillance process being a process for handling the specified backdoor block as a subject that should be monitored when the specified backdoor block is executed.

### Second Example Embodiment

A second example embodiment relates to a more specific example embodiment.

### Example of Configuration of Software Correcting Apparatus

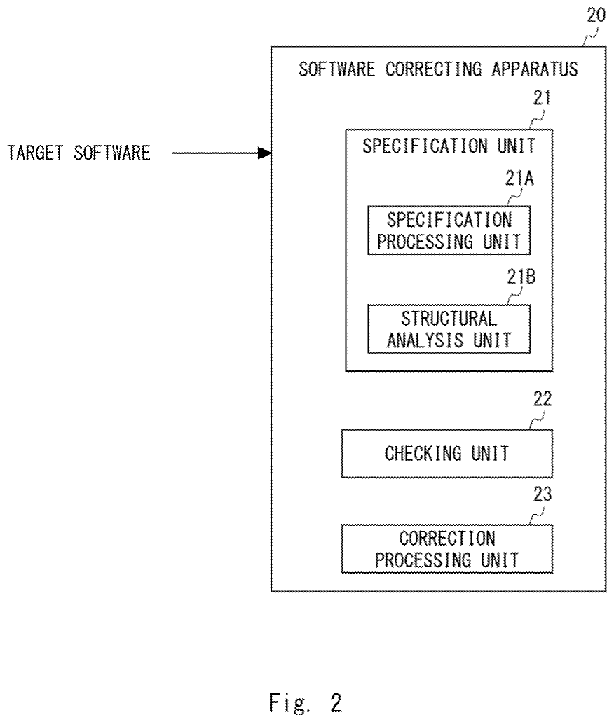

FIG. 2 is a block diagram showing an example of a software correcting apparatus according to a second example embodiment. In FIG. 2, a software correcting apparatus 20 includes a specification unit 21, a checking unit 22, and a correction processing unit 23.

Similarly to the specification unit 11 in the first example embodiment, the specification unit 21 specifies a plurality of “code blocks” contained in a target software. For example, as shown in FIG. 2, the specification unit 21 includes a specification processing unit 21A and a structural analysis unit 21B.

The specification processing unit 21A specifies the form of the subject software, i.e., specifies whether the target software is a source code or a binary code. In the following description, information about the form of the target software is also referred to as “form information”.

Further, the specification processing unit 21A specifies a “predetermined code block” corresponding to a “predefined predetermined function” in the target software. Examples of the “predefined predetermined function” include an “interface function”, an “authentication function (authentication routine)”, and a “command parser function (parser routine)”. That is, the “predefined predetermined function” is a function that is followed by various functions. That is, the “predefined predetermined function” corresponds to a code block that serves as a starting point in a control flow graph of the target software.

The specification processing unit 21A may, for example, specify a predetermined code block by using a “specification rule table (“first specification table”)” in which each of a plurality of predetermined functions is associated with a feature of a predetermined code block corresponding to that predetermined function. In this case, the specification processing unit 21A specifies, for each of predetermined code blocks recorded in the specification rule table, a part of the target software that matches the feature of that predetermined code block as a predetermined code block. Further, the specification processing unit 21A may specify a predetermined code block by, instead of using the table, executing one or a plurality of algorithms or modules for specifying a predetermined function.

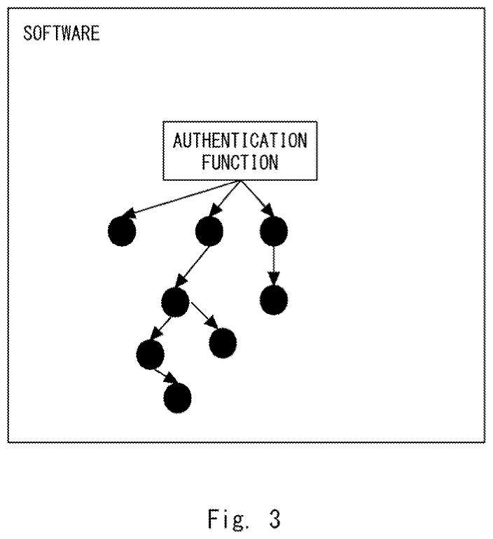

The structural analysis unit 21B analyzes the structure of the target software by tracing the control flow starting from the predetermined code block specified by the specification processing unit 21A, and also specifies code blocks corresponding to functions other than the predetermined function. For example, the structural analysis unit 21B traces the control flow graph starting from the code block of the authentication function specified by the specification processing unit 21A, and thereby creates the control flow graph like the one shown in FIG. 3. Then, the structural analysis unit 21B specifies code blocks corresponding to functions other than the predetermined function by using a “specification rule table (“second specification table”)”. In the “second specification table”, types of code blocks that may serve as a starting point are associated with features of specific target code blocks that should be specified according to the types. For example, in the “second specification table”, a “code block of an authentication function”, which is a code block that may serve as a starting point, is associated with a “code block that is present after going through the authentication routine in the control flow graph” as a “feature of a specific target code block. Further, for example, in the “second specification table”, a “code block of a command parser function”, which is a code block that may serve as a starting point, is associated with a “function block containing a command or a function that is dispatched after an input is parsed by a parser” as a “feature of a specific target code block. Note that in the control flow graph shown in FIG. 3, each of the “code blocks of the authentication function” and the “specific target code blocks (represented by circles in FIG. 3)” can also be referred to as a “node”. Further, in the control flow graph shown in FIG. 3, arrows correspond to control flows.

Similarly to the checking unit 12 in the first example embodiment, the checking unit 22 specifies a backdoor block(s).

As a first example, the checking unit 22 specifies a “code block for performing a comparison with a fixed value that is not mentioned in the specifications” from among the plurality of code blocks specified by specification unit 21, and specifies this specified code block as a “backdoor block”.

As a second example, when there is a path that reaches a code block corresponding to an execution part that requires authentication without going through an authentication code block in the control flow graph, the checking unit 22 specifies, from among the plurality of code blocks specified by specification unit 21, a code block corresponding to this path as a “backdoor block”

As a third example, the checking unit 22 specifies, from among the plurality of code blocks specified by specification unit 21, a code block containing a command (or a function) that is not mentioned in the specifications as a “backdoor block”.

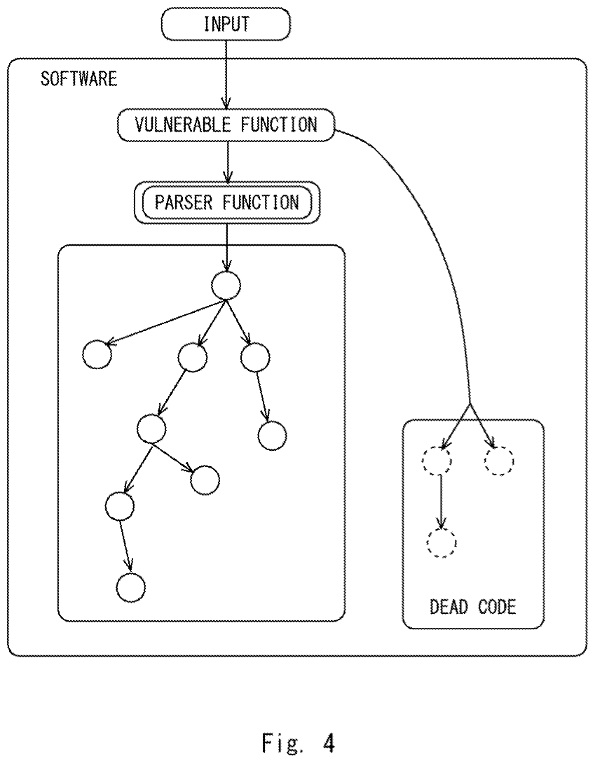

As a fourth example, the checking unit 22 specifies, from among the plurality of code blocks specified by specification unit 21, a code block that cannot be traced in the control flow graph created in specification unit 21 (i.e., a dead code) as a “backdoor block”. FIG. 4 is diagram for explaining such a dead code.

As a fifth example, the checking unit 22 specifies, from among the plurality of code blocks specified by specification unit 21, a code block that could exhibit behavior that is not mentioned in the specifications as a “backdoor block”.

Then, the checking unit 22 assigns a “backdoor score” to each of the specified backdoor blocks. For example, the checking unit 22 assigns a “backdoor score” to each of the specified backdoor blocks according to the type of the backdoor block. Higher the score value of the “backdoor score” is, the more likely it indicates that the backdoor block is a backdoor. The checking unit 22 may assign a backdoor score to each of the specified backdoor blocks according to the type by using a “score table” in which each of a plurality of types of backdoor blocks is associated with a backdoor score according to that type.

For example, in the score table, a backdoor score value higher than a “determination threshold” (which will be described later) is assigned to each of the backdoor types corresponding to the above-described first to fourth examples, respectively, while a backdoor score value lower than the “determination threshold” is assigned to the backdoor type corresponding to the above-described fifth example.

Similarly to the correction processing unit 13 in the first example embodiment, the correction processing unit 23 performs an “execution-disabling process” or a “putting-under-surveillance process” on a backdoor block(s) contained in the target software.

For example, the correction processing unit 23 determines (i.e., selects), based on the “form information” specified by the specification unit 21, an “execution process” to be performed on the backdoor block from among the “removal process”, the “invalidation process”, and the “insertion process”. For example, when the “form information” received from the specification unit 21 indicates a source code, the correction processing unit 23 determines (i.e., selects) the “removal process” as the “execution process”. Note that when the “removal process” is performed, it may be checked whether or not no problem will occur when the target software, from which the backdoor block has been removed, is actually executed.

On the other hand, when the “form information” indicates a binary code, the correction processing unit 23 determines (i.e., selects) the “invalidation process” or the “insertion process” as the “execution process”. For example, when the form information corresponding to the backdoor block to be processed indicates a binary code and the backdoor score value corresponding to the backdoor block to be processed is higher than the “determination threshold”, the correction processing unit 23 determines (i.e., selects) the “invalidation process” as the “execution process”. Further, when the form information corresponding to the backdoor block to be processed indicates a binary code and the backdoor score value corresponding to the backdoor block to be processed is equal to or lower than the “determination threshold”, the correction processing unit 23 determines (i.e., selects) the “insertion process” as the “execution process”.

For example, in the “invalidation process”, the correction processing unit 23 rewrites the backdoor block into an “invalid instruction”. The “invalid instruction” is, for example, a NOP (No OPeration) instruction or an instruction for performing exception handling. Further, a binary code may be managed (e.g., recorded) over a plurality of pages in memory management. Therefore, when there is a page occupied by a backdoor block in the software, the correction processing unit 23 may invalidate that page in the “invalidation process”.

Further, for example, in the “insertion process”, the correction processing unit 23 may insert a monitoring code into the target software by Binary instrumentation. The monitoring code may be, for example, a code for collecting a log (e.g., keeping a log) or outputting an alert when the backdoor block is executed.

It should be noted that it is technically difficult to add a new code in a binary code and to delete a code present in a binary code. Therefore, when a correction is made to a binary code, a code (instruction) in the binary code is written or a code is inserted thereinto by binary instrumentation. In contrast, when a correction is made to a source code, a backdoor code is removed from the source code. Then, after removing the backdoor code, a binary code may be created by compiling the source code.

### Example of Operation of Software Correcting Apparatus

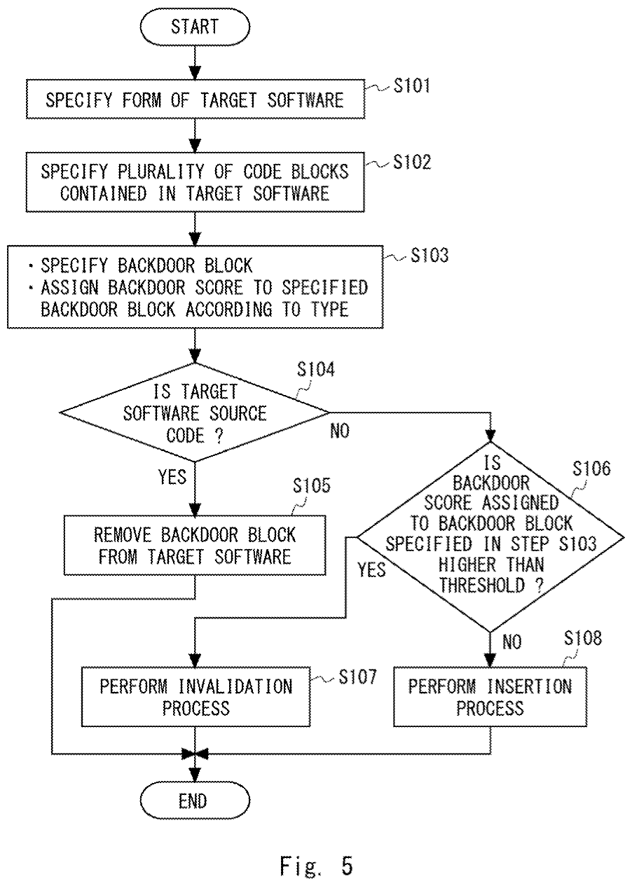

An example of processing operations performed by the software correcting apparatus 20 having the above-described configuration will be described. FIG. 5 is a flowchart showing an example of the processing operations performed by the software correcting apparatus according to the second example embodiment.

The specification unit 21 receives a target software and specifies the form of this target software (Step S101).

The specification unit 21 specifies a plurality of code blocks contained in the target software (Step S102).

The checking unit 22 specifies a backdoor block(s) and assigns a backdoor score to the specified backdoor block according to the type thereof (Step S103).

The correction processing unit 23 determines whether or not the target software is a source code (Step S104).

When the target software is a source code (Yes at Step S104), the correction processing unit 23 removes the backdoor block from the target software (Step S105). Note that when a plurality of backdoor blocks are specified in the step S103, all the backdoor blocks are removed from the target software.

When the target software is not a source code, i.e., when the target software is a binary code (No at Step S104), the correction processing unit 23 determines whether or not the backdoor score assigned to the backdoor block in the step S103 is higher than a determination threshold (Step S106).

When the backdoor score is higher than the determination threshold (Yes at Step S106), the correction processing unit 23 performs an “invalidation process” on the backdoor block (Step S107). Further, when the backdoor score is equal to or lower than the determination threshold (No at Step S106), the correction processing unit 23 performs an insertion process in which it inserts a monitoring code before (i.e., in front of) the backdoor block in the target software (Step S108).

Note that when a plurality of backdoor blocks are specified in the step S103, the correction processing unit 23 repeats the processing steps in the steps S106, S107 and S108 for each of the plurality of backdoor blocks.

As described above, according to the second example embodiment, in the software correcting apparatus 20, the correction processing unit 23 determines (i.e., selects) the “execution process” to be performed on the backdoor block from among the “removal process”, the “invalidation process”, and the “insertion process” based on the “form information” indicating whether the target software is a source code or a binary code.

By the above-described configuration of the software correcting apparatus 20, it is possible to cope with a backdoor block according to the form of the target software.

Further, in the software correcting apparatus 20, the correction processing unit 23 determines (i.e., selects), based on the backdoor score in addition to the form information, the execution process to be performed on the backdoor block from among the removal process, the invalidation process, and the insertion process. The backdoor score is a score that indicates a possibility that the backdoor block is a backdoor.

By the above-described configuration of the software correcting apparatus 20, it is possible to cope with a backdoor block according to the possibility that the backdoor block is a backdoor.

### Other Example Embodiment

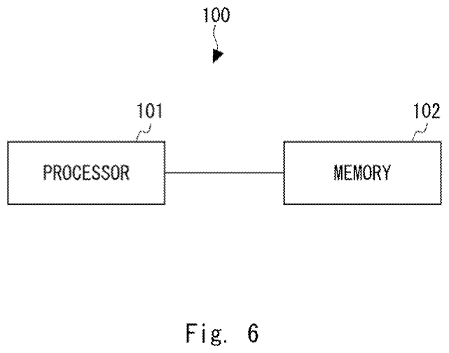

FIG. 6 shows an example of a hardware configuration of a software correcting apparatus. In FIG. 6, the software correcting apparatus includes a 25 processor 101 and a memory 102. The processor 101 may be, for example, a microprocessor, an MPU (Micro Processing Unit), or a CPU (Central Processing Unit). The processor 101 may include a plurality of processors. The memory 102 is composed of a combination of a volatile memory and a nonvolatile memory. The memory 102 may include a storage located remotely from the 30 processor 101. In this case, the processor 101 may access the memory 102 through an I/O interface (not shown).

Each of the software correcting apparatuses 10 and 20 according to the first and second example embodiments can have a hardware configuration shown in FIG. 6. The specification units 11 and 21, the checking units 12 and 22, and the correction processing units 13 and 23 of the software correcting apparatuses 10 and 20 according to the first and second example embodiments may be implemented by having the processor 101 load and execute a program(s) stored in the memory 102. The program can be stored and supplied to the software correcting apparatuses 10 and 20 by using various types of non-transitory computer readable media. Examples of non-transitory computer readable media include magnetic recording media (e.g., flexible disks, magnetic tapes, and hard disk drives) and magneto-optical recording media (e.g., magneto-optical disks). Examples of non-transitory computer readable media also include CD-ROM (Read

Only Memory), CD-R, and CD-R/W. Examples of non-transitory computer readable media also include semiconductor memories. Examples of semiconductor memories include mask ROM, PROM (Programmable ROM), EPROM (Erasable PROM), flash ROM, and RAM (Random Access Memory). Further, the program may also be supplied to the software correcting apparatuses 10 and 20 by various types of transitory computer readable media. Examples of transitory computer readable media include electrical signals, optical signals, and electromagnetic waves. The transitory computer readable media can supply the program to the software correcting apparatuses 10 and 20 through a wired channel such as an electric wire and an optical fiber, or through a wireless channel.

Although the present invention is described above with reference to example embodiments, the present invention is not limited to the above-described example embodiments. Various modifications that can be understood by those skilled in the art can be made to the configuration and details of the present invention within the scope of the invention.

The whole or part of the example embodiments disclosed above can be described as, but not limited to, the following supplementary notes.

### (Supplementary Note 1)

A software correcting apparatus comprising:
specification means for specifying a plurality of code blocks contained in software to be checked;
checking means for determining, for each of the specified code blocks, whether or not the specified code block is a code block that is possibly a backdoor, and specifying a code block that is determined to be possibly a backdoor as a backdoor block; and
correction processing means for performing an execution-disabling process or a putting-under-surveillance process on the backdoor block contained in the software, the execution-disabling process being a process for changing the state of the specified backdoor block into a state in which it cannot be executed, and the putting-under-surveillance process being a process for handling the specified backdoor block as a subject that should be monitored when the specified backdoor block is executed.

### (Supplementary Note 2)

The software correcting apparatus described in Supplementary note 1, wherein
the execution-disabling process includes a removal process for removing the backdoor block from the software or an invalidation process for invalidating the backdoor block, and
the putting-under-surveillance process includes an insertion process for inserting a monitoring code for monitoring the backdoor block into the software.

### (Supplementary Note 3)

The software correcting apparatus described in Supplementary note 2, wherein
the specification means comprises:
specification processing means for specifying a predetermined code block corresponding to a predefined predetermined function, and
structural analysis means for analyzing a structure of the software and specifying a code block corresponding to a function other than the predetermined function by tracing a control flow starting from the specified predetermined code block.

### (Supplementary Note 4)

The software correcting apparatus described in Supplementary note 2 or 3, wherein the correction processing means determines, based on form information indicating whether the software is a source code or a binary code, an execution process to be performed on the backdoor block from among the removal process, the invalidation process, and the insertion process.

### (Supplementary Note 5)

The software correcting apparatus described in Supplementary note 4, wherein
the checking means determines a score indicating a possibility that the backdoor block is a backdoor block, and
the correction processing means determines, based on the form information and the score, the execution process to be performed on the backdoor block from among the removal process, the invalidation process, and the insertion process.

### (Supplementary Note 6)

The software correcting apparatus described in Supplementary note 5, wherein when the software is a source code, the correction processing means determines the removal process as the execution process.

### (Supplementary Note 7)

The software correcting apparatus described in Supplementary note 5 or 6, wherein when the software is a binary code and the score is higher than a threshold, the correction processing means determines the invalidation process as the execution process, whereas when the software is a binary code and the score is equal to or lower than the threshold, the correction processing means determines the insertion process as the execution process.

### (Supplementary Note 8)

The software correcting apparatus described in Supplementary note 2, wherein the correction processing means rewrites the backdoor block into an invalid instruction in the invalidation process.

### (Supplementary Note 9)

The software correcting apparatus described in Supplementary note 2, wherein when there is a page included in the software and occupied by the backdoor block, the correction processing means invalidates the page in the invalidation process.

### (Supplementary Note 10)

A software correcting method comprising:
specifying a plurality of code blocks contained in software to be checked;
determining, for each of the specified code blocks, whether or not the specified code block is a code block that is possibly a backdoor, and specifying a code block that is determined to be possibly a backdoor as a backdoor block; and
performing an execution-disabling process or a putting-under-surveillance process on the backdoor block contained in the software, the execution-disabling process being a process for changing the state of the specified backdoor block into a state in which it cannot be executed, and the putting-under-surveillance process being a process for handling the specified backdoor block as a subject that should be monitored when the specified backdoor block is executed.

### (Supplementary Note 11)

A non-transitory computer readable medium storing a program for causing a software correcting apparatus to:
specify a plurality of code blocks contained in software to be checked;
determine, for each of the specified code blocks, whether or not the specified code block is a code block that is possibly a backdoor, and specify a code block that is determined to be possibly a backdoor as a backdoor block; and
perform an execution-disabling process or a putting-under-surveillance process on the backdoor block contained in the software, the execution-disabling process being a process for changing the state of the specified backdoor block into a state in which it cannot be executed, and the putting-under-surveillance process being a process for handling the specified backdoor block as a subject that should be monitored when the specified backdoor block is executed.

### REFERENCE SIGNS LIST

10 SOFTWARE CORRECTING APPARATUS
11 SPECIFICATION UNIT
12 CHECKING UNIT
13 CORRECTION PROCESSING UNIT
20 SOFTWARE CORRECTING APPARATUS
21 SPECIFICATION UNIT
21A SPECIFICATION PROCESSING UNIT
21B STRUCTURAL ANALYSIS UNIT
22 CHECKING UNIT
23 CORRECTION PROCESSING UNIT

What is claimed is:

1. A software correcting apparatus comprising:
at least one memory storing instructions, and
at least one processor configured to execute, according to the instructions, a process comprising:
specifying a plurality of code blocks contained in software to be checked;
determining, for each of the specified code blocks, whether or not the specified code block is a code block that is possibly a backdoor, and specifying a code block that is determined to be possibly a backdoor as a backdoor block; and
performing an execution-disabling process or a putting-under-surveillance process on the backdoor block contained in the software, the execution-disabling process being a process for changing the state of the specified backdoor block into a state in which it cannot be executed, and the putting-under-surveillance process being a process for handling the specified backdoor block as a subject that should be monitored when the specified backdoor block is executed.

2. The software correcting apparatus according to claim 1, wherein
the execution-disabling process includes a removal process for removing the backdoor block from the software or an invalidation process for invalidating the backdoor block, and
the putting-under-surveillance process includes an insertion process for inserting a monitoring code for monitoring the backdoor block into the software.

3. The software correcting apparatus according to claim 2, wherein
the specifying a plurality of code blocks comprises:
specifying a predetermined code block corresponding to a predefined predetermined function, and
analyzing a structure of the software and specifying a code block corresponding to a function other than the predetermined function by tracing a control flow starting from the specified predetermined code block.

4. The software correcting apparatus according to claim 2, wherein the performing an execution-disabling process or a putting-under-surveillance process includes determining, based on form information indicating whether the software is a source code or a binary code, an execution process to be performed on the backdoor block from among the removal process, the invalidation process, and the insertion process.

5. The software correcting apparatus according to claim 4, wherein
the specifying a plurality of code blocks includes determining a score indicating a possibility that the backdoor block is a backdoor block, and
the performing an execution-disabling process or a putting-under-surveillance process includes determining, based on the form information and the score, the execution process to be performed on the backdoor block from among the removal process, the invalidation process, and the insertion process.

6. The software correcting apparatus according to claim 5, wherein the performing an execution-disabling process or a putting-under-surveillance process includes determining the removal process as the execution process when the software is a source code.

7. The software correcting apparatus according to claim 5, wherein the performing an execution-disabling process or a putting-under-surveillance process includes:
determining, when the software is a binary code and the score is higher than a threshold, the invalidation process as the execution process, and
determining, when the software is a binary code and the score is equal to or lower than the threshold the insertion process as the execution process.

8. The software correcting apparatus according to claim 2, wherein the performing an execution-disabling process or a putting-under-surveillance process includes rewriting the backdoor block into an invalid instruction in the invalidation process.

9. The software correcting apparatus according to claim 2, wherein the performing an execution-disabling process or a putting-under-surveillance process includes invalidating, when there is a page included in the software and occupied by the backdoor block, the page in the invalidation process.

10. A software correcting method comprising:
specifying a plurality of code blocks contained in software to be checked;
determining, for each of the specified code blocks, whether or not the specified code block is a code block that is possibly a backdoor, and specifying a code block that is determined to be possibly a backdoor as a backdoor block; and
performing an execution-disabling process or a putting-under-surveillance process on the backdoor block contained in the software, the execution-disabling process being a process for changing the state of the specified backdoor block into a state in which it cannot be executed, and the putting-under-surveillance process being a process for handling the specified backdoor block as a subject that should be monitored when the specified backdoor block is executed.

11. A non-transitory computer readable medium storing a program for causing a software correcting apparatus to:
specify a plurality of code blocks contained in software to be checked;
determine, for each of the specified code blocks, whether or not the specified code block is a code block that is possibly a backdoor, and specify a code block that is determined to be possibly a backdoor as a backdoor block; and
perform an execution-disabling process or a putting-under-surveillance process on the backdoor block contained in the software, the execution-disabling process being a process for changing the state of the specified backdoor block into a state in which it cannot be executed, and the putting-under-surveillance process being a process for handling the specified backdoor block as a subject that should be monitored when the specified backdoor block is executed.
